(19) United States
(12) Patent Application Publication
(10) Pub. No.: US 2017/0155988 A1
(43) Pub. Date: Jun. 1, 2017

(54) SOUNDBOX

(71) Applicants: LE HOLDINGS (BEIJING) CO., LTD., , Beijing (CN); LE SHI ZHI XIN ELECTRONIC TECHNOLOGY (TIANJIN) LIMITED, , Beijing (CN)

(72) Inventors: Shiming QING, , Beijing (CN); Peifeng GAO, , Beijing (CN); Zhaoqian XU, , Beijing (CN)

(21) Appl. No.: 15/242,123

(22) Filed: Aug. 19, 2016

Related U.S. Application Data
(63) Continuation of application No. PCT/CN2016/083049, filed on May 23, 2016.

(30) Foreign Application Priority Data
Nov. 30, 2015 (CN) 2015209763643

(51) Int. Cl. H04R 1/02; H04R 1/28

(52) U.S. Cl. CPC H04R 1/026; H04R 1/288

(57) ABSTRACT

A soundbox is disclosed in the disclosure, including a guiding pillar (1) and a guiding sleeve (3) within the soundbox, the guiding sleeve (3) being sleeved outside the guiding pillar (1), a shockproof sleeve (2) being sleeved outside the guiding pillar (1), the shockproof sleeve (2) being positioned between the outer wall surface of the guiding pillar (1) and the inner wall surface of the guiding sleeve (3), to fill the gap between the guiding pillar (1) and the guiding sleeve (3).

### CROSS REFERENCE TO RELATED APPLICATIONS

This application is a continuation of International Application No. PCT/CN2016/083049 filed on May 23, 2016, which is based upon and claims priority to Chinese Patent Application No. 201520976364.3, filed on Nov. 30, 2015, the entire contents of which are incorporated herein by reference.

### TECHNICAL FIELD

The present application relates to a soundbox, particularly to a shockproof device for an easily-detachable guiding rail in the soundbox.

### BACKGROUD

Currently, in the (i.e. soundbox) field of soundbar and smart soundbar, internal PCB plates are all directly fixed within the interior of the cavity when designing internal structure of the soundbox, which is not conducive to upgrade the hardware and maintain.

In view of the above disadvantage, in the prior art, a structure of an easily-detachable guiding rail is used. As shown in FIG. 1 to FIG. 3, a mating structure of a guiding pillar and a guiding sleeve in the existing structure of the easily-detachable guiding rail is depicted. The advantage of this structure is easy to detach. However, when assembling the guiding pillar and the guiding sleeve, a gap may occur. In the course of the operation of the soundbox, a speaker generates vibration, and the guiding pillar and the guiding sleeve may cause tremolo due to the gap. For products within the soundbox, even a slight assembling gap generated may cause tremolo due to the vibration, which affects acoustical quality. Therefore, this is undoubtedly a fatal problem for products of requirements of high performance and high quality.

### SUMMARY

The object of the embodiments of the present disclosure is to provide a soundbox which can eliminate tremolo.

In order to achieve the above object, a specific technical solution of the soundbox of an embodiment of the present disclosure is:

A shockproof device of a guiding rail structure of a soundbox product, including a guiding pillar and a guiding sleeve within the soundbox, the guiding sleeve being sleeved outside the guiding pillar, a shockproof sleeve being sleeved outside the guiding pillar, the shockproof sleeve being positioned between the outer wall surface of the guiding pillar and the inner wall surface of the guiding sleeve, to fill the gap between the guiding pillar and the guiding sleeve.

Further, a plurality of recessed shock absorbing grooves are provided on the outer surface of the shockproof sleeve.

Further, a protrusion is provided on the open end of the shockproof sleeve, the shockproof sleeve being fixed on the guiding pillar by inserting the protrusion into a recess of the guiding pillar.

The advantage of the soundbox of the embodiment of the present disclosure is in that, by adding a shockproof device between the guiding pillar and the guiding sleeve, when vibrating, the shockproof device will resiliently contact the guiding sleeve, which eliminates the problem of the tremolo caused by vibration, so that the acoustical quality will not be affected.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a sectional view of a guiding pillar in a soundbox;

FIG. 2 is a sectional view of a guiding sleeve in a soundbox;

FIG. 3 is a diagram of assembled guiding pillar and guiding sleeve in the prior art;

FIG. 4 is a sectional view of a shockproof sleeve in the present disclosure;

FIG. 5 is a structural schematic diagram of a shockproof sleeve in the present disclosure;

FIG. 6 is a diagram of assembled shockproof sleeve and guiding pillar in the present disclosure;

FIG. 7 is a diagram of an assembled shockproof device in the present disclosure.

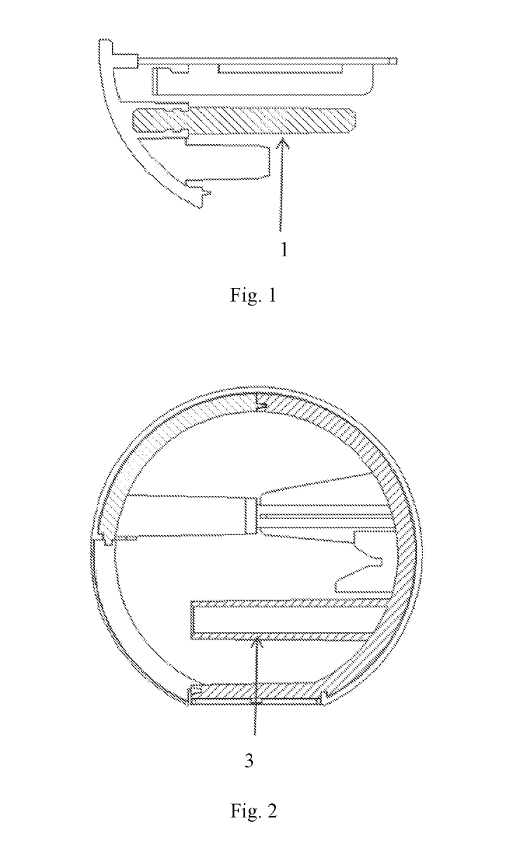

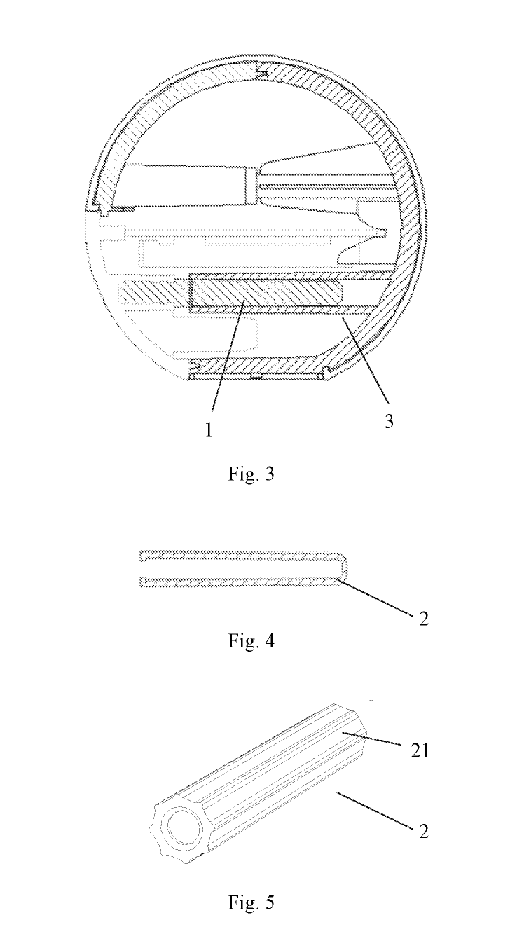

### DETAILED DESCRIPTION

The exemplary embodiments of the disclosure will be described in further detail with reference to the drawings below. Though the exemplary embodiments of the disclosure are depicted in the drawings, it should be understood that the disclosure may be implemented in various ways and is not limited by embodiments set forth herein. Instead, those embodiments are provided so that the disclosure will be understood more thoroughly and the scope of the disclosure will be fully conveyed to the skill person in the art.

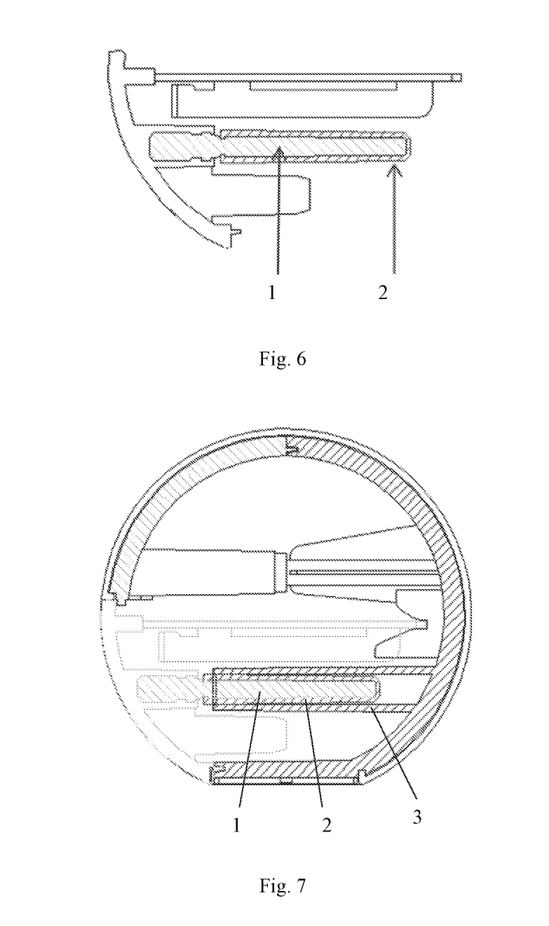

The embodiments of the present disclosure disclose a soundbox. As shown in FIG. 4 to FIG. 7, a guiding rail structure is provided within the soundbox. The guiding rail structure includes a guiding pillar 1 and a guiding sleeve 3, the guiding sleeve 3 is sleeved outside the guiding pillar 1 and a shockproof sleeve 2 is provided between the guiding sleeve 3 and the guiding pillar 1. The shockproof sleeve 2 is used for filling the gap between the guiding pillar 1 and the guiding sleeve 3 to prevent the guiding pillar 1 from vibrating within the guiding sleeve 3. When the soundbox vibrates, the speaker generates vibration. However, by using the shockproof sleeve 2, the contact of the guiding pillar 1 with the guiding sleeve 3 can be avoided, and the problem of tremolo caused by vibration can be eliminated, so that the acoustical quality will not be affected.

Further, as shown in FIG. 5, the shockproof sleeve 2 is sleeved outside the guiding pillar 1, and is provided between and closely contacts the outer wall surface of the guiding pillar 1 and the inner wall surface of the guiding sleeve 3. The shockproof sleeve 2 is a resilient structure and can be a washer having elasticity, which can expand and contract according to the size of the gap between the guiding pillar 1 and guiding sleeve 3. Wherein, a silicon rubber sleeve is used as the shockproof sleeve 2 in the present invent, but the shockproof sleeve 2 is not limited thereto.

Further, as shown in FIG. 4, one end of the shockproof sleeve 2 is a closed end and the other end is an open end. A protrusion protruding inward is provided on the open end and the protrusion is of an annular form. One end of the guiding pillar 1 is accommodated within the closed end of the shockproof sleeve 2 and a recess is provided on the other end. The protrusion is sleeved within the recess of the guiding pillar 1, so as to fix the shockproof sleeve 2 on the guiding pillar 1 and to prevent the shockproof sleeve 2 from slipping off when entering the guiding sleeve 3.

Further, as shown in FIG. 5, the shockproof sleeve 2 is a sleeve-like body which can surround the guiding pillar 1. After being sleeved outside the guiding pillar 1, the shockproof sleeve is of a closed shape. A plurality of recessed shock absorbing grooves 21 are provided on the outer surface of the shockproof sleeve 2, along the longitudinal direction of the shockproof sleeve. The shock absorbing grooves 21 are uniformly distributed on the shockproof sleeve 2 with spacing provided therebetween.

In the soundbox of the embodiments of the present disclosure, by adding a shockproof device between the guiding pillar and the guiding sleeve, when vibrating, the silicon rubber sleeve will resiliently contact the guiding sleeve, which eliminates the problem of the tremolo caused by vibration, so that the acoustical quality will not be affected.

The present disclosure has been further described by means of the specific embodiment above, however, it should be understood that the specific description herein should not be construed to limit the scope and the substance of the present invent. The various modifications to the above embodiments that those ordinary skilled in the art make after reading the specification are within the scope of the claimed invention.

1-9. (canceled)

10. A soundbox, wherein a guiding rail structure is provided within the soundbox, the guiding rail structure including a guiding pillar and a guiding sleeve, the guiding sleeve being sleeved outside the guiding pillar and a shockproof sleeve being provided between the guiding sleeve and the guiding pillar, the shockproof sleeve being used for filling the gap between the guiding pillar and the guiding sleeve to prevent the guiding pillar from vibrating within the guiding sleeve.

11. The soundbox according to claim 10, wherein the shockproof sleeve is sleeved outside the guiding pillar, and is positioned between the outer wall surface of the guiding pillar and the inner wall surface of the guiding sleeve.

12. The soundbox according to claim 10, wherein the shockproof sleeve is a resilient structure.

13. The soundbox according to claim 10, wherein one end of the shockproof sleeve is a closed end and the other end is an open end, and one end of the guiding pillar is accommodated within the closed end of the shockproof sleeve.

14. The soundbox according to claim 13, wherein a protrusion protruding inward is provided on the open end of the shockproof sleeve.

15. The soundbox according to claim 14, wherein the protrusion on the shockproof sleeve is of an annular form.

16. The soundbox according to claim 13, wherein a recess is provided on the other end of the guiding pillar, and the protrusion on the shockproof sleeve is sleeved within the recess of the guiding pillar so as to fix the shockproof sleeve on the guiding pillar.

17. The soundbox according to claim 10, wherein a recessed shock absorbing groove is provided on the outer surface of the shockproof sleeve.

18. The soundbox according to claim 17, wherein a plurality of shock absorbing grooves are provided on the shockproof sleeve.
